(19) United States
(12) Patent Application Publication
(10) Pub. No.: US 2003/0112710 A1
(43) Pub. Date: Jun. 19, 2003

(54) Reducing thermal drift in electronic components

(76) Inventors: John C. Eidson, Palo Alto, CA (US); Stanley P. Woods, Cupertino, CA (US); Hans Sitte, San Jose, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/026,059

(22) Filed: Dec. 18, 2001

(51) Int. Cl. G06F 1/04; G04F 5/00

(52) U.S. Cl. 368/156

(57) ABSTRACT

A variety of techniques for low cost reduction of thermal drift in electronic components. These techniques include structures for increasing the thermal mass of an electronic component and for insulating an electronic component from thermal drift caused by air flow as well as structures for thermally isolating an electronic component from heat flow on a circuit board.

### BACKGROUND OF THE INVENTION

1. Field of Invention

The present invention pertains to the field of electronics. More particularly, this invention relates to reducing thermal drift in electronic components.

2. Art Background

A variety of electronic components have characteristics that vary with temperature. A variation in the characteristics of an electronic component with temperature may be referred to as thermal drift. For example, the frequency at which a crystal component vibrates usually exhibits thermal drift. In another example, the offset current of an operation amplifier typically exhibits thermal drift.

The temperature of an electronic component may change due to a variety of factors. For example, high temperature devices may conduct heat to an electronic component via the signal lines on an electronic circuit board and via the circuit board itself. In addition, variations in air flow over an electronic component usually change its temperature.

Thermal drift in an electronic component may cause a variety of problems. For example, the thermal drift of a crystal component usually causes a drift in the frequency of clock signals derived from the vibration of the crystal component. In addition, different crystal components in different clock circuits usually exhibit different rates of thermal drift. Such differences in thermal drift combined with the ambient temperature drift itself hinders efforts to maintain accuracy and/or synchronization among the clock signals generated by the clock circuits.

One prior method for minimizing the effect of thermal drift on an electronic component is to employ specialized manufacturing techniques. For example, crystal components may be manufactured using specialized oven control techniques. Unfortunately, such specialized manufacturing techniques usually increase the costs of electronic components.

Another prior method for minimizing the effect of thermal drift on an electronic component is to provide specialized circuitry as an add-on to the component that compensates for the effects of thermal drift. Unfortunately, such compensation circuitry usually imposes relatively high costs.

### SUMMARY OF THE INVENTION

A variety of techniques are disclosed for low cost reduction of thermal drift that changes characteristics of electronic components. These techniques include structures for increasing the thermal mass of an electronic component and for insulating an electronic component from thermal drift caused by air flow as well as structures for thermally isolating an electronic component from heat flow on a circuit board. Each of these techniques may be used alone or in any combination with the other techniques.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 shows an electronic component mounted on a circuit board in accordance with the prior art;

FIG. 2 shows an arrangement for reducing thermal drift in an electronic component using a structure that increases its thermal mass;

FIG. 3 shows an arrangement for reducing thermal drift in an electronic component using a structure that insulates it from air flow;

FIG. 4 shows an arrangement for reducing thermal drift in an electronic component using a structure that increases its thermal mass and insulates it from air flow;

FIG. 5 shows an arrangement for reducing thermal drift in an electronic component by thermally isolating it from heat flow;

FIGS. 6a-6b show other arrangements for reducing thermal drift in an electronic component by thermally isolating it from heat flow;

FIG. 7 shows a distributed system which employs the present techniques for reducing thermal drift in electronic components.

### DETAILED DESCRIPTION

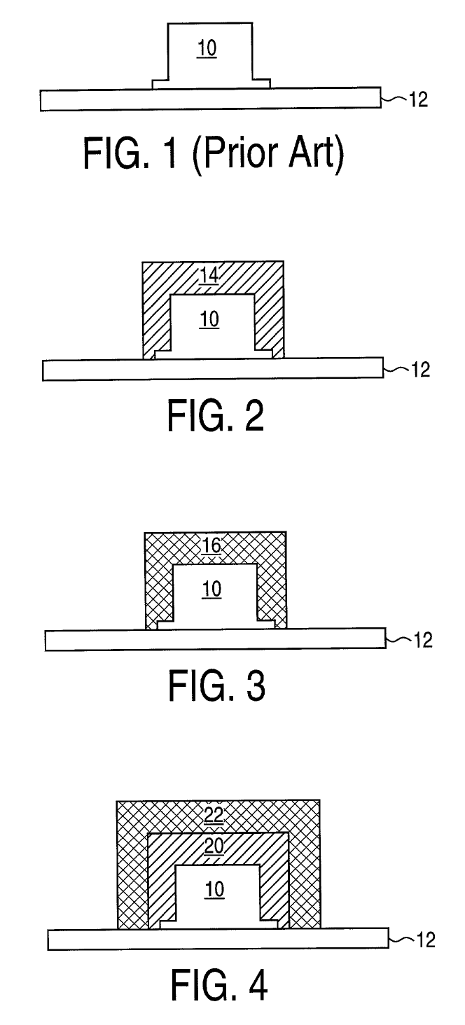

FIG. 1 shows an electronic component 10 mounted on a circuit board 12 in accordance with the prior art. The temperature of the electronic component 10 changes in response to heat flowing through signal lines (not shown) on the circuit board 12 and the circuit board 12 itself and in response to air flow over the circuit board 12 as well as to changes in ambient temperature in the environment of the circuit board 12.

FIG. 2 shows an arrangement for reducing thermal drift in the electronic component 10 using a structure that increases its thermal mass. In this arrangement, the thermal mass of the electronic component 10 is increased using a structure such as a metal case 14. The metal case 14 may be copper or aluminum to name a few examples. Alternatively, a ceramic case may be used to increase the thermal mass of the electronic component 10.

For example, if the metal case 14 increases the thermal mass of the electronic component by a factor of 10 then the thermal drift rate of the electronic component may be reduced by a factor of 10 in response to heat flow through signal lines and circuit board and/or air flow and/or ambient temperature changes.

FIG. 3 shows an arrangement for reducing thermal drift in the electronic component 10 using a structure that insulates it from air flow. In this arrangement, the electronic component 10 is encapsulated in an insulator 16. The insulator 16 is a thermal insulator that reduces the influence of air flow and changes in ambient temperature on the temperature of the electronic component 10, thereby reducing thermal drift rate. The insulator 16 may be foam or Styrofoam to name a couple of examples.

FIG. 4 shows an arrangement for reducing thermal drift in the electronic component 10 using a structure that increases its thermal mass and insulates it from air flow. In this arrangement, the thermal mass of the electronic component 10 is increased using a metal case 20 and the influence of ambient temperature changes and air flow is reduced using an insulator 22 that encases the electronic component 10 and the metal case 20.

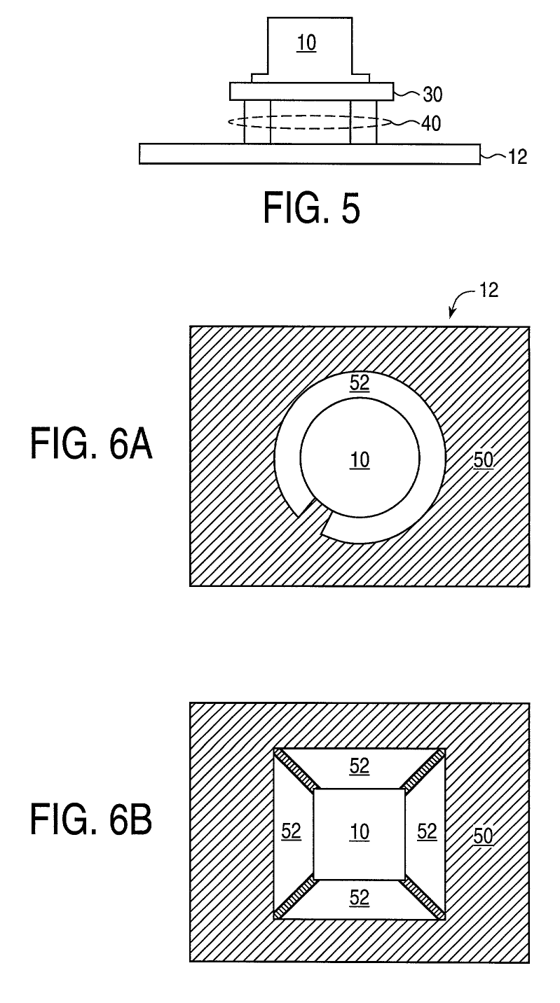

FIG. 5 shows an arrangement for reducing thermal drift in the electronic component 10 by thermally isolating it from heat flow. In this arrangement, the electronic component 10 is mounted on a circuit board 30 which is thermally isolated from the heat flowing in the circuit board 12 by the space in between. The electronic component 10 connects to the circuit board 12 through a set of leads 40 of the electronic component 10.

In the arrangement shown in FIG. 5, the electronic component 10 may be augmented with a metal or ceramic case to increase its thermal mass. Alternatively, the electronic component 10 may be encased in an insulator. In another alternative, the electronic component 10 may be augmented with a metal or ceramic case to increase its thermal mass and then encased in an insulator.

FIGS. 6a-6b show other arrangements for reducing thermal drift in the electronic component 10 by thermally isolating it from heat flow. A top view of a ground plane 50 contained in the circuit board 12 is shown. In this embodiment, a gap 52 is provided between the ground plane 50 and the electronic component 10 to minimize the conduction of heat from the ground plane 50 to the electronic component 10.

The electronic component 10 which is isolated from the ground plane 50 by the gap 52 may be augmented with a metal or ceramic case to increase its thermal mass and/or encased in an insulator.

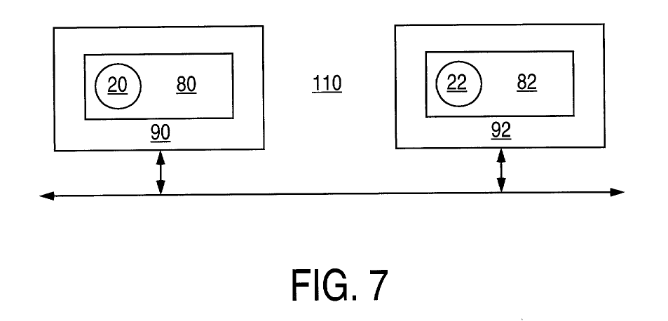

FIG. 7 shows a distributed system 110 which employs the present techniques for reducing thermal drift in electronic components. The distributed system 110 includes a pair of nodes 90-92 which communicate via a network 100. The nodes 90-92 have corresponding local clocks 80-82 which are based on corresponding local crystal components 70-72. Each node 90-92 includes communication circuitry for communication via the network 100. The communication circuitry may include the appropriate hardware/software protocol stack for communication according to a protocol of the network 100.

In one embodiment, the local clocks 80-82 maintain synchronization with respect to one another by exchanging timing messages via the network 100. For example, each local clock 80-82 may include circuitry for measuring the transmit and receive times of the timing messages and for using the measured times to compute adjustments to local time values. The local clocks 80-82 may each include a counter driven by an oscillator which is based on the corresponding crystal component 70-72. The counters may be incremented or decremented based on computations involving the transmit and receive times of the timing messages. Alternatively, other hardware and/or software based clock synchronization techniques may be implemented in the nodes 90-92 to maintain synchronization among the local clocks 80-82.

The greater the thermal drift among the crystal components 70-72 the more the local clocks 80-82 fall out of synchronization and the more timing messages must be transferred to maintain synchronization. An increase in timing messages reduces available bandwidth on the network 100.

The nodes 90-92 may be located in environments having different ambient temperature characteristics and air flow characteristics which could cause different thermal drift rates in the crystal components 70-72. In addition, the circuitry implemented on the node 90 may have different temperature characteristics than circuitry implemented on the node 92 which could cause different thermal drift rates in the crystal components 70-72.

Any one or more of the low cost techniques described above may be used to reduce the effects of thermal drift on one or more characteristics of the crystal components 70-72—for example the frequency at which the crystal components 70-72 vibrate. The reduction of thermal drift in the crystal components 70-72 reduces timing drift among the local clocks 80-82 and thereby reduces the rate of timing messages needed to maintain synchronization among the local clocks 80-82. The reduction of timing messages increases available bandwidth on the network 100 and potentially reduces overall communication costs.

The foregoing detailed description of the present invention is provided for the purposes of illustration and is not intended to be exhaustive or to limit the invention to the precise embodiment disclosed. Accordingly, the scope of the present invention is defined by the appended claims.

What is claimed is:

1. A circuit, comprising:
electronic component;
structure for reducing thermal drift in the electronic component.

2. The circuit of claim 1, wherein the structure comprises a material that increases a thermal mass of the electronic component.

3. The circuit of claim 2, wherein the material comprises a metal case around the electronic component.

4. The circuit of claim 2, wherein the material comprises a ceramic case around the electronic component.

5. The circuit of claim 1, wherein the structure comprises an insulator.

6. The circuit of claim 1, wherein the structure comprises a material that increases a thermal mass of the electronic component and an insulator that encases the electronic component and the material.

7. The circuit of claim 1, wherein the structure comprises a circuit board that holds the electronic component which is separated from a circuit board that holds a set of other components of the circuit.

8. The circuit of claim 7, wherein the structure further comprises a material that increases a thermal mass of the electronic component.

9. The circuit of claim 7, wherein the structure further comprises an insulator over the electronic component.

10. The circuit of claim 7, wherein the structure further comprises a material that increases a thermal mass of the electronic component and an insulator that encases the electronic component and the material.

11. The circuit of claim 1, wherein the structure comprises a gap which reduces a heat conduction path a ground plane in a circuit board and the electronic component.

12. The circuit of claim 1, wherein the circuit is an oscillator circuit.

13. The circuit of claim 1, wherein the circuit is a clock circuit.

14. The circuit of claim 12, further comprising:
means for communication via a network;
means for synchronizing a local time value in the clock circuit in response to a set of messages transferred via the network.

15. A distributed system having a set of nodes, each node comprising:
local clock including a crystal component;
structure for reducing thermal drift in the electronic component.

16. The distributed system of claim 15, wherein the structure comprises a material that increases a thermal mass of the electronic component.

17. The distributed system of claim 16, wherein the material comprises a metal case around the electronic component.

18. The distributed system of claim 16, wherein the material comprises a ceramic case around the electronic component.

19. The distributed system of claim 15, wherein the structure comprises an insulator.

20. The distributed system of claim 15, wherein the structure comprises a material that increases a thermal mass of the electronic component and an insulator that encases the electronic component and the material.
